(19) United States
(12) Patent Application Publication
(10) Pub. No.: US 2025/0279111 A1
(43) Pub. Date: Sep. 4, 2025

(54) SOUND MODIFICATION USING MACHINE LEARING CLASSIFICATION

(71) Applicant: Sony Group Corporation, Tokyo (JP)

(72) Inventors: Justin Kenefick, San Diego, CA (US); James R. Milne, San Diego, CA (US)

(73) Assignee: Sony Group Corporation, Tokyo (JP)

(21) Appl. No.: 18/595,221

(22) Filed: Mar. 4, 2024

(51) Int. Cl. G10L 21/034; G06F 3/16; G10L 15/06; G10L 15/183; G10L 15/22; G10L 21/028; G10L 25/51

(52) U.S. Cl. CPC G10L 21/034; G06F 3/165; G10L 15/063; G10L 15/183; G10L 15/22; G10L 21/028; G10L 25/51; G10L 2015/223

(57) ABSTRACT

A method includes receiving input from a user that identifies types of audio as positive audio or negative audio. The method further includes outputting, with a large language model, a classification of the types of audio that the user identified as positive audio or negative audio. The method further includes identifying, with a microphone, audio in a physical environment. The method further includes splitting, with an audio machine-learning model, the audio into audio sources. The method further includes outputting, with the large language model, one or more matched audio sources that are matched with the one or more types of audio that the user categorized as positive audio or negative audio. The method further includes modifying output of an auditory device based on the one or more matched audio sources, wherein a positive audio source is amplified and a negative audio source is reduced or cancelled.

### BACKGROUND

Hearing aids and other auditory devices are used to block out or amplify noises. However, some sounds may be desirable while other sounds are undesirable. Technology exists to manually change the settings to increase or decrease the sounds in an environment; however, taking steps to manually make changes is time consuming. Furthermore, if the noise is too loud, the user may suffer hearing damage and/or discomfort while manually changing the settings on the auditory device.

### SUMMARY

A computer-implemented method includes receiving input from a user that identifies types of audio as positive audio or negative audio. The method further includes outputting, with a large language model, a classification of the types of audio that the user identified as positive audio or negative audio. The method further includes identifying, with a microphone, audio in a physical environment. The method further includes splitting, with an audio machine-learning model, the audio into audio sources. The method further includes outputting, with the large language model, one or more matched audio sources that are matched with the one or more types of audio that the user categorized as positive audio or negative audio. The method further includes modifying output of an auditory device based on the one or more matched audio sources, wherein a positive audio source is amplified and a negative audio source is reduced or cancelled.

In some embodiments, the method further includes responsive to receiving the input from the user, generating a user interface that includes a list of the types of audio that the user identified as positive audio or negative audio, wherein the user interface includes options for specifying a degree of positive audio or a degree of negative audio and generating a user profile based on the input from the user. In some embodiments, the method further includes detecting, with the microphone, an instruction from a user to increase or decrease a volume of a type of sound; classifying, with the large language model, a particular type of audio based on the instruction from the user; splitting, with the audio machine-learning model, the audio in the physical environment to isolate the particular type of audio; and modifying the output of the auditory device based on the instruction from the user to increase or decrease the volume of particular type of audio. In some embodiments, the method further includes updating the user profile to categorize the type of sound as positive audio or negative audio based on the instruction from the user. In some embodiments, the method further includes detecting, with the microphone, an instruction from a user to increase a volume of a person; classifying, with the large language model, a particular type of audio based on the instruction from the user; and modifying output of the auditory device to increase the volume of the person. In some embodiments, the instruction from the user further includes an identification of a location of the person as identified by the large language model and classifying the particular type of audio is further based on the location of the person. In some embodiments, the large language model is trained by receiving training data that includes audio files and descriptions of the audio files; outputting, with an audio encoder, embedded audio; generating audio tokens; tokenizing the descriptions of the audio files; outputting, with a text embedding layer, text tokens; and providing pairs of audio tokens and corresponding text tokens to the large language model for training. In some embodiments, the positive audio source is amplified and the negative audio source is reduced or cancelled based on a degree of amplification or reduction input by the user.

In some embodiments, a system comprises one or more processors and logic encoded in one or more non-transitory media for execution by the one or more processors and when executed are operable to: receive input from a user that identifies types of audio as positive audio or negative audio; output, with a large language model, a classification of the types of audio that the user identified as positive audio or negative audio; identify, with a microphone, audio in a physical environment; split, with an audio machine-learning model, the audio into audio sources; output, with the large language model, one or more matched audio sources that are matched with the one or more types of audio that the user categorized as positive audio or negative audio; and modify output of an auditory device based on the one or more matched audio sources, wherein a positive audio source is amplified and a negative audio source is reduced or cancelled.

In some embodiments, the logic is further operable to responsive to receiving the input from the user, generate a user interface that includes a list of the types of audio that the user identified as positive audio or negative audio, wherein the user interface includes options for specifying a degree of positive audio or a degree of negative audio; and generate a user profile based on the input from the user. In some embodiments, the logic is further operable to detect, with the microphone, an instruction from a user to increase or decrease a volume of a type of sound; classify, with the large language model, a particular type of audio based on the instruction from the user; split, with the audio machine-learning model, the audio in the physical environment to isolate the particular type of audio; and modify the output of the auditory device based on the instruction from the user to increase or decrease the volume of particular type of audio. In some embodiments, the logic is further operable to update the user profile to categorize the type of sound as positive audio or negative audio. In some embodiments, the logic is further operable to detect, with the microphone, an instruction from a user to increase a volume of a person; classify, with the large language model, a particular type of audio based on the instruction from the user; and modify output of the auditory device to increase the volume of the person. In some embodiments, the instruction from the user further includes an identification of a location of the person as identified by the large language model and classifying the particular type of audio is further based on the location of the person.

In some embodiments, software encoded in one or more computer-readable media for execution by one or more processors of an auditory device and when executed is operable to receive input from a user that identifies types of audio as positive audio or negative audio; output, with a large language model, a classification of the types of audio that the user identified as positive audio or negative audio; identify, with a microphone, audio in a physical environment; split, with an audio machine-learning model, the audio into audio sources; output, with the large language model, one or more matched audio sources that are matched with the one or more types of audio that the user categorized as positive audio or negative audio; and modify output of an auditory device based on the one or more matched audio sources, wherein a positive audio source is amplified and a negative audio source is reduced or cancelled.

In some embodiments, the software is further operable to responsive to receiving the input from the user, generate a user interface that includes a list of the types of audio that the user identified as positive audio or negative audio, wherein the user interface includes options for specifying a degree of positive audio or a degree of negative audio; and generate a user profile based on the input from the user. In some embodiments, the software is further operable to detect, with the microphone, an instruction from a user to increase or decrease a volume of a type of sound; classify, with the large language model, a particular type of audio based on the instruction from the user; split, with the audio machine-learning model, the audio in the physical environment to isolate the particular type of audio; and modify the output of the auditory device based on the instruction from the user to increase or decrease the volume of particular type of audio. In some embodiments, the software is further operable to update the user profile to categorize the type of sound as positive audio or negative audio. In some embodiments, the software is further operable to detect, with the microphone, an instruction from a user to increase a volume of a person; classify, with the large language model, a particular type of audio based on the instruction from the user; and modify output of the auditory device to increase the volume of the person. In some embodiments, the instruction from the user further includes an identification of a location of the person as identified by the large language model and classifying the particular type of audio is further based on the location of the person.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example network environment according to some embodiments described herein.

FIG. 2 is an illustration of example auditory devices according to some embodiments described herein.

FIG. 3A is a block diagram of an example auditory device according to some embodiments described herein.

FIG. 3B is a block diagram of an example digital signal processor according to some embodiments described herein.

FIG. 4 illustrates an example user interface of audio sources identified by a user as being positive audio sources or negative audio sources according to some embodiments described herein.

FIG. 5 is an example process of training a large language model to classify audio according to some embodiments described herein.

FIG. 6 illustrates a flowchart of an example method to modify output of an auditory device based on one or more matched audio sources according to some embodiments described herein.

### DETAILED DESCRIPTION OF EMBODIMENTS

Determining which portion of audio in a physical environment to amplify, pass through, and/or suppress is a complicated process. Current technology exists for manually modifying certain sounds; however, this technology takes too long and may harm the user's hearing while the user manually adjusts the settings on their auditory device.

One solution may include training a machine-learning model to classify different types of audio sources. However, the classification of all types of audio presents a technical issue because the training results in a machine-learning model with memory demands that exceed the capacity of a mobile device, much less the capacity of smaller auditory devices, such as hearing aids. In addition, this type of machine-learning model may be unable to react in real-time due to the processing demands required by such a bulky model.

The technology described below advantageously solves the technical problems by using a large language model that is part of a hearing application to create a profile of types of audio that a user identifies as positive audio or negative audio, where a positive audio source is to be amplified and a negative audio source is to be reduced or cancelled. The large language model uses a description of the type of audio provided by the user to identify the types of audio that are then matched with sounds in a physical environment.

In some embodiments, the hearing application may also respond in real-time to instructions from the user and update the profile accordingly. For example, if the user is walking down a street and talking to another person while a construction worker is using a jackhammer, the user may instruct the auditory device to increase the volume of the person and decrease the volume of the jackhammer.

### Example Environment 100

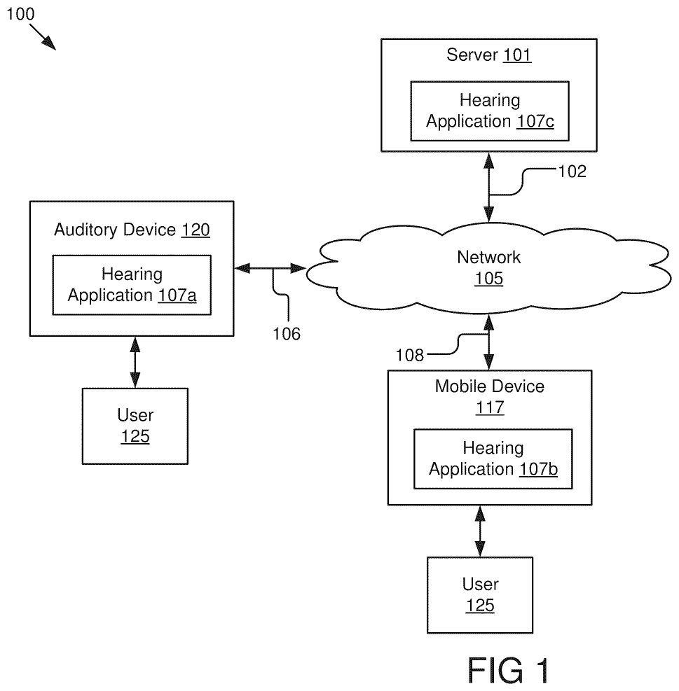

FIG. 1 illustrates a block diagram of an example environment 100. In some embodiments, the environment 100 includes an auditory device 120, a mobile device 117, and a server 101. A user 125 may be associated with the mobile device 117 and the auditory device 120. In some embodiments, the environment 100 may include other servers or devices not shown in FIG. 1. In FIG. 1 and the remaining figures, a letter after a reference number, e.g., “107a,” represents a reference to the element having that particular reference number (e.g., a hearing application 107a stored on the mobile device 117). A reference number in the text without a following letter, e.g., “107,” represents a general reference to embodiments of the element bearing that reference number (e.g., any hearing application 107).

The auditory device 120 may include a processor, a memory, a speaker, and network communication hardware. The auditory device 120 may be a hearing aid, earbuds, headphones, etc.

The auditory device 120 is communicatively coupled to the network 105 via signal line 106. Signal line 106 may be a wired connection, such as Ethernet, coaxial cable, fiber-optic cable, etc., or a wireless connection, such as Wi-Fi®, Bluetooth®, or other wireless technology.

In some embodiments, the auditory device 120 includes a hearing application 107a that performs hearing tests. For example, the user 125 may be asked to identify sounds emitted by speakers of the auditory device 120 and the user may provide user input, for example, by pressing a button on the auditory device 120, such as when the auditory device 120 is a hearing aid, earbuds, or headphones. In some embodiments where the auditory device 120 is larger, such as when the auditory device 120 is a speaker device, the auditory device 120 may include a display screen that receives touch input from the user 125.

In some embodiments, the auditory device 120 communicates with a hearing application 107b stored on the mobile device 117. During testing, the auditory device 120 receives instructions from the mobile device 117 to emit test sounds at particular decibel levels. Once testing is complete, the auditory device 120 receives a hearing profile that includes instructions for how to modify sound based on different factors, such as frequencies, types of sounds, one or more audio presets, etc.

The mobile device 117 may be a computing device that includes a memory, a hardware processor, and a hearing application 107b. The mobile device 117 may include a smartphone, a tablet computer, a laptop, a mobile telephone, a wearable device, a head-mounted display, a mobile email device, or another electronic device capable of accessing a network 105 to communicate with one or more of the server 101 and the auditory device 120.

In some embodiments the mobile device 117 includes a display. For example, if the mobile device 117 is a smartphone, the smartphone may include a touch-sensitive display that displays a user interface for a user. The user interface may display options for testing the user's hearing, for providing input about a user's preferences for different audio sources, etc.

In the illustrated implementation, mobile device 117 is coupled to the network 105 via signal line 108. Signal line 108 may be a wired connection, such as Ethernet, coaxial cable, fiber-optic cable, etc., or a wireless connection, such as Wi-Fi®, Bluetooth®, or other wireless technology. The mobile device 117 is used by way of example. While FIG. 1 illustrates one mobile device 117, the disclosure applies to a system architecture having one or more mobile devices 117.

The hearing application 107 includes logic that is operable to receive input from a user that identifies types of audio as positive audio or negative audio. The input may be spoken, input into a user interface, or provided in other ways. The hearing application 107 includes a large language model that outputs a classification of the types of audio that the user identified as positive audio or negative audio.

Audio is identified in a physical environment. The hearing application 107 includes an audio machine-learning model that splits the audio into audio sources. For example, if the user is outside, the audio may be split into traffic noises, rain noises, walking noises, people speaking, etc. If the user is inside an office, the audio may be split into keyboard noises, music, people speaking, etc.

The hearing application 107 outputs, with the large language model, one or more matched audio sources that are matched with the one or more types of audio that the user categorized as positive audio or negative audio. The hearing application 107 modifies output of the auditory device 120 based on the one or more matched audio sources, where a positive audio source is amplified and a negative audio source is reduced or cancelled. For example, if the hearing application 107a is stored on the auditory device 120, the hearing application 107a instructs the processor and/or the digital signal processor to amplify, reduce, or cancel the audio. If the hearing application 107b is stored on the mobile device 117, the hearing application 107b instructs the auditory device 120 to amplify, reduce, or cancel the audio.

The server 101 may include a processor, a memory, and network communication hardware. In some embodiments, the server 101 is a hardware server. The server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the server 101 includes a hearing application 107c. In some embodiments and with user consent, the hearing application 107c on the server 101 maintains a copy of the hearing profile.

In some embodiments, the hearing application 107c on the server 101 includes the trained large language model and/or the trained audio machine-learning model and provides information to the auditory device 120 and/or the mobile device 117 about audio profiles to take advantage of greater processing power provided by the server 101. For example, the large language model may generate audio profiles for each audio source identified by the user as being a positive audio source or a negative audio source.

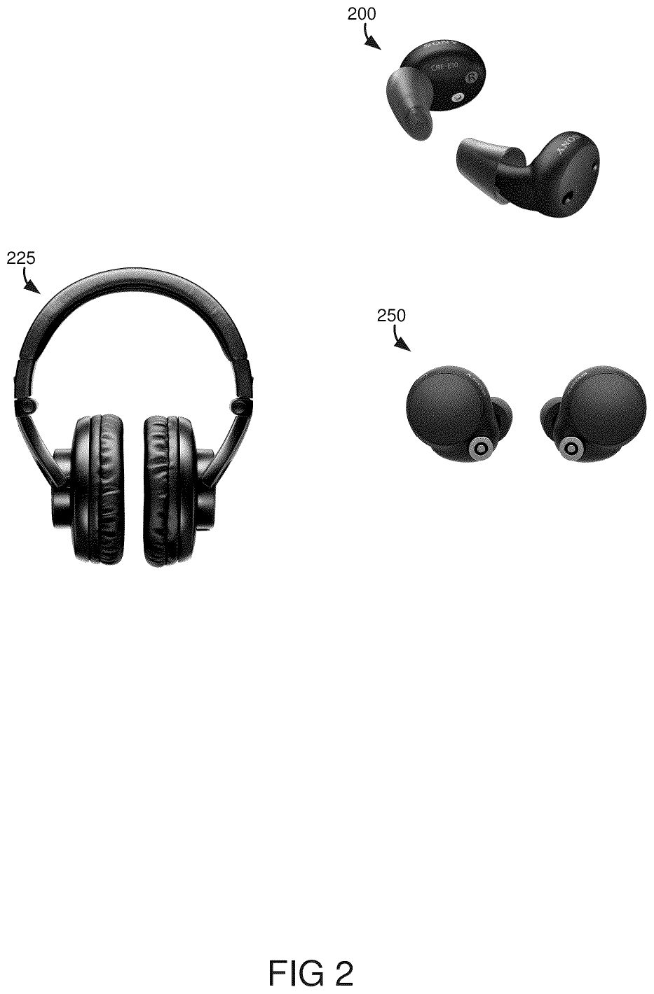

FIG. 2 illustrates example auditory devices. Specifically, FIG. 2 illustrates a hearing aid 200, headphones 225, and earbuds 250. In some embodiments, each of the auditory devices is operable to receive instructions from the hearing application 107 to apply the one or more audio presets.

### Example Computing Device 300

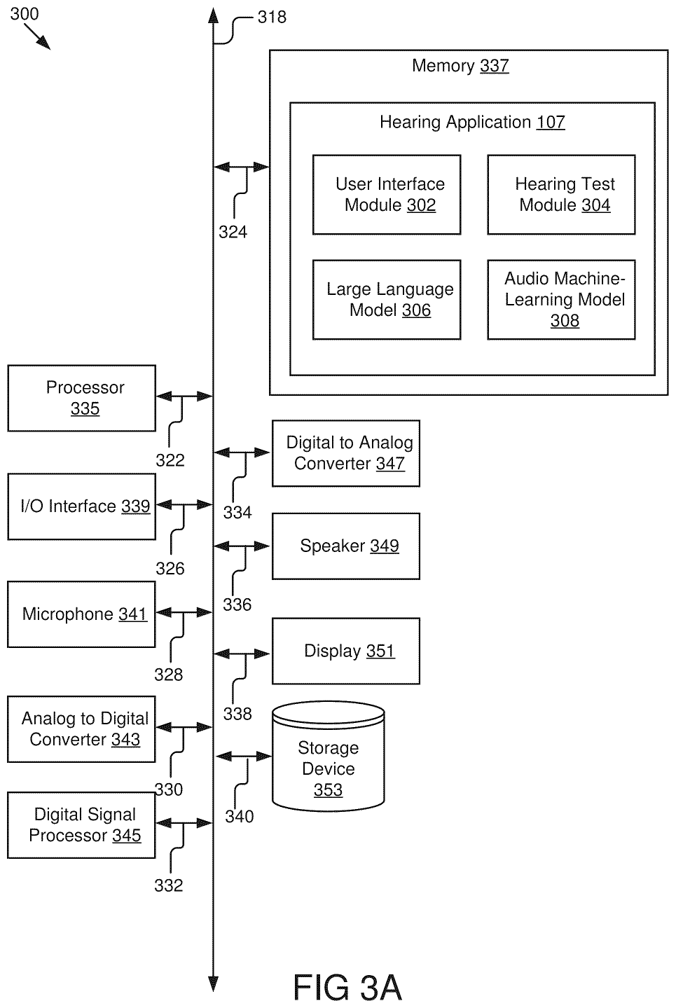

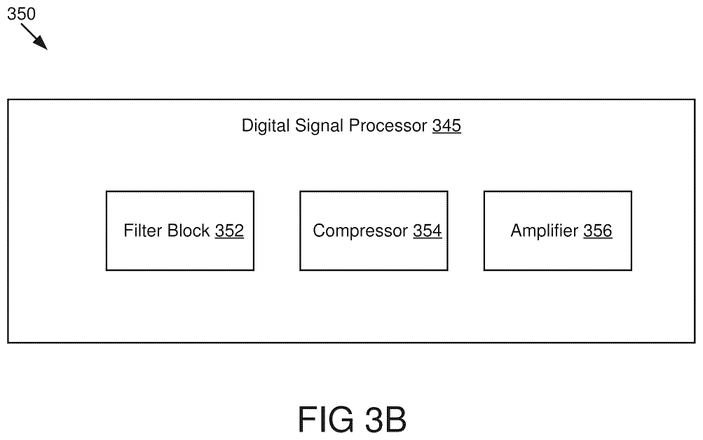

FIG. 3A is a block diagram of an example computing device 300 that may be used to implement one or more features described herein. The computing device 300 can be any suitable computer system or other electronic or hardware device. In some embodiments, the computing device 300 is the auditory device 120 in FIG. 1. In some embodiments, the computer device 300 is the mobile device 117 in FIG. 1. In some embodiments, some portions of the computing device 300 are performed by the auditory device 120, some portions of the computing device 300 are performed by the mobile device 117, and some portions of the computing device 300 are performed by the server 101 in FIG. 1.

In some embodiments, computing device 300 includes a processor 335, a memory 337, an Input/Output (I/O) interface 339, a microphone 341, an analog to digital converter 343, a digital signal processor 345, a digital to analog converter 347, a speaker 349, a display 351, and a storage device 353. The processor 335 may be coupled to a bus 318 via signal line 322, the memory 337 may be coupled to the bus 318 via signal line 324, the I/O interface 339 may be coupled to the bus 318 via signal line 326, the microphone 341 may be coupled to the bus 318 via signal line 328, the analog to digital converter 343 may be coupled to the bus 318 via signal line 330, the digital signal processor 345 may be coupled to the bus 318 via signal line 332, the digital to analog converter 347 may be coupled to the bus 318 via signal line 334, the speaker 349 may be coupled to the bus 318 via signal line 336, the display 351 may be coupled to the bus 318 via signal line 338, and the storage device 353 may be coupled to the bus 318 via signal line 340.

The processor 335 can be one or more processors and/or processing circuits to execute program code and control basic operations of the computing device 300. A processor includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, or other systems. A computer may be any processor in communication with a memory.

The memory 337 is typically provided in computing device 300 for access by the processor 335 and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 335 and/or integrated therewith. Memory 337 can store software operating on the computing device 300 by the processor 335, including the hearing application 107.

The I/O interface 339 can provide functions to enable interfacing the computing device 300 with other systems and devices. Interfaced devices can be included as part of the computing device 300 or can be separate and communicate with the computing device 300. For example, network communication devices, storage devices (e.g., the memory 337 or the storage device 353), and input/output devices can communicate via I/O interface 339.

In some embodiments, the I/O interface 339 handles communication between the computing device 300 and the mobile device via a wireless protocol, such as Wi-Fi®, Bluetooth®, Near Field Communication (NFC), Radio Frequency Identification (RFID), Ultra-Wideband (UWB), infrared, etc. In some embodiments, the I/O interface 339 provides information to the mobile device that identifies a type of the auditory device that is wirelessly connected to the mobile device.

The microphone 341 includes hardware for detecting sounds. For example, the microphone 341 may detect ambient noises, people speaking, music, etc. The microphone 341 receives acoustical sound signals and converts the signals to analog electrical signals. The analog to digital converter 343 converts the analog electrical signals to digital electrical signals.

The digital signal processor 345 includes hardware for converting the digital electrical signals into a digital output signal. Turning to FIG. 3B, an example digital signal processor 345 is illustrated. In some embodiments, the digital signal processor 345 includes a filter block 352, a compressor 354, and an amplifier 356.

The filter block 352 includes hardware that may apply a filter to the digital electrical signals. For example, the filter block 352 may apply a filter that removes sounds corresponding to a particular frequency or that modifies the sound level associated with the particular frequency. For example, the filter block 352 may include a high-frequency shelf that prevents a sound level of the background noise from exceeding a high-frequency protection preset curve based on a frequency of the background noise.

The compressor 354 may include hardware that is used to compress the dynamic range of input sounds so that they more closely match the dynamic range desired by the user while ensuring that the sounds are audible to the user. In some embodiments, the compressor 354 adjusts the gain of signals at a particular frequency where the user has hearing loss. For example, if a user has hearing loss at a higher frequency, the compressor 354 may adjust the gain of those signals.

The amplifier 346 is used to amplify certain sounds based on a particular setting. For example, the amplifier 346 may apply a gain to particular frequencies when a user has been identified as suffering hearing loss at those particular frequencies. In some embodiments, the amplifier 346 reduces or blocks a signal heard by the user by sending an inverted signal that sums with the outside noise before it reaches the user's ear. The amplifier 346 transmits the digital output signal to a digital to analog converter 347.

The digital to analog converter 347 may include hardware that is used to convert the digital output signal into an analog electrical signal, which is used by the speaker 349 to produce an audio signal that is heard by the user. In some embodiments, the speaker 349 emits instructions for the user, such as instructions to rotate.

In some embodiments where the computing device 300 is a mobile device, the computing device 300 includes a display 351. The display 351 may connect to the I/O interface 339 to display content, e.g., a user interface, and to receive touch (or gesture) input from a user. The display 351 can include any suitable display device such as a liquid crystal display (LCD), light emitting diode (LED), or plasma display screen, television, monitor, touchscreen, or other visual display device.

The storage device 353 stores data related to the hearing application 107. For example, the storage device 353 may store hearing profiles generated by the hearing application 107, sets of test sounds, a hearing profile, training data for a machine-learning model, and one or more audio presets associated with particular locations.

Although particular components of the computing device 300 are illustrated, other components may be added or removed.

### Example Hearing Application 107

The hearing application 107 includes a user interface module 302, a hearing test module 304, a large language model 306, and an audio machine-learning module 308. Different modules may be stored on different types of computing devices. For example, a first computing device 300 may be an auditory device that includes the hearing test module 304, the large language model 306, and the audio machine-learning model 308. A second computing device may be a mobile device that includes the user interface module 302.

The user interface module 302 generates graphical data for displaying a user interface. In some embodiments, a user downloads the hearing application 107 onto a mobile device. The user interface module 302 may generate graphical data for displaying a user interface where the user provides input that the hearing test module 304 uses to generate a hearing profile for a user. For example, the user may provide a username and password, input their name, and provide an identification of an auditory device (e.g., identify whether the auditory device is a hearing aid, headphones, or earbuds).

In some embodiments, the user interface includes an option for specifying a particular type of auditory device and a particular model that is used during testing. For example, the hearing aids may be Sony C10 self-fitting over-the-counter hearing aids (model CRE-C10) or E10 self-fitting over-the-counter hearing aids (model CRE-E10). The identification of the type of auditory device is used for, among other things, determining a beginning decibel level for the test sounds. For example, because hearing aids, earbuds, and headphones are so close to the ear (and are possibly positioned inside the ear), the beginning decibel level for a hearing aid is 0 decibels.

In some embodiments, once the user has selected a type of auditory device, the user interface module 302 generates a user interface for specifying a model of the auditory device. For example, the user interface module 302 may generate graphical data for displaying a list of different types of Sony headphones. For example, the list may include WH-1000XM4 wireless Sony headphones, WH-CH710N wireless Sony headphones, MDR-ZX110 wired Sony headphones, etc. Other headphones including headphones manufactured by companies other than Sony may be selected. In some embodiments, the user interface module 302 may generate graphical data to display a list of models from other manufacturers.

The user interface module 302 generates graphical data for displaying a user interface that allows a user to select a hearing test. For example, the hearing test module 304 may implement pink noise band testing, speech testing, music testing, etc. In some embodiments, the user may select which type of test is performed first. In some embodiments, before testing begins, the user interface includes an instruction for the user to move to an indoor area that is quiet and relatively free of background noise.

In some embodiments, the user interface module 302 generates graphical data for displaying a user interface to select a number of listening bands for the hearing testing. For example, the user interface may include radio buttons for selecting a particular number of listening bands or a field where the user may enter a number of listening bands.

Once the different tests begin, in some embodiments, the user interface module 302 generates graphical data for displaying a user interface with a way for the user to identify when the user hears a sound generated by the auditory device. For example, the user interface may include a button that the user can select when the user hears a sound. In some embodiments, the user interface module 302 generates a user interface during speech testing that includes a request to identify a particular word from a list of words. This helps identify words or sound combinations that the user may have difficulty hearing.

In some embodiments, the user interface module 302 may generate graphical data for displaying a user interface that allows a user to repeat the hearing tests. For example, the user may feel that the results are inaccurate and may want to test their hearing to see if there has been an instance of hearing loss that was not identified during testing. In another example, a user may experience a change to their hearing conditions that warrants a new test, such as a recent infection that may have caused additional hearing loss.

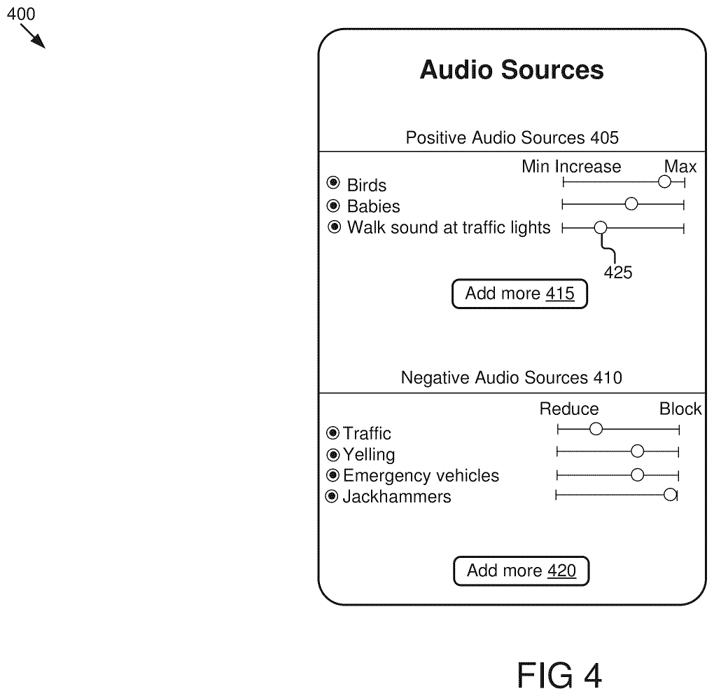

In some embodiments, the user interface module 302 generates a user interface that is used for generating a user profile of positive audio sources and negative audio sources associated with the user. FIG. 4 illustrates an example user interface 400 of audio sources identified by a user as being positive audio sources 405 or negative audio sources 410. In this example, the user has provided birds, babies, and walk sound at traffic lights as the positive audio sources 405 and traffic, yelling, emergency vehicles, and jackhammers as the negative audio sources 410.

The items may be input via a text field, through a speech-to-text translation service, from a pull-down menu, etc. New items may be added by selecting the add more button 415 for positive audio sources 405 or the add more button 420 for negative audio sources 410.

Each item may be associated with a degree of positive audio or negative audio. The degree may be expressed as a value (e.g., 1 out of 100), a percentage (e.g., 10%), a gradation (e.g., low, medium, high), etc. In FIG. 4, the degree is illustrated with a slider. For example, the slider 425 for the walk sound at traffic lights is slightly less than half. As a result, the auditory device increases the walk sound by about 40% and the user may increase the slider 425 if it is not loud enough.

In some embodiments, the user interface module 302 updates the user interface based on feedback from the user. For example, if a user asks for the auditory device to block out the sound of an espresso machine because the user is at a coffee shop, the user interface may update the user interface to include espresso machine as an item under negative audio sources 410 with the slider moved all the way to the block edge of the degree range.

The hearing test module 304 conducts a hearing test by instructing the processor 335 and/or the digital signal processor 345 to generate sounds. In some embodiments, the hearing test is administered by a user marking in a user interface displayed on the mobile device whether the user heard a particular sound. In some embodiments, the hearing test module 304 stored on the mobile device generates the hearing profile once testing is complete and transmits the hearing profile to the mobile device.

The hearing test module 304 generates a hearing profile after receiving user input provided via the user interface. For example, the hearing test module 304 instructs the auditory device to play a sound at a particular decibel level, receives user input via the user interface when the user can hear the sound, and generates a hearing profile that indicates a frequency at which the user can hear the sound. The hearing test module 304 may use multiple types of tests. For example, the hearing test module 304 may implement pink band testing that determines the decibels at which pink bands are audible to users. The hearing test module 304 may also implement speech testing to determine circumstances when speech is most audible to the user and implement music testing to determine circumstances when music is most audible to the user.

In some embodiments, the hearing test module 304 modifies the hearing profile to include instructions for producing sounds based on a corresponding frequency according to a Fletcher Munson curve. The Fletcher Munson curve identifies a phenomenon of human hearing where, as an actual loudness changes, the perceived loudness that a human's brain hears will change at a different rate, depending on the frequency. For example, at low listening volumes mid-range frequencies sound more prominent, while the low and high frequency ranges seem to fall into the background. At high listening volumes the lows and highs sound more prominent, while the mid-range seems comparatively softer.

In some embodiments, the hearing test module 304 receives an audiometric profile from the server and compares the hearing profile to the audiometric profile in order to make recommendations for the user. In some embodiments, the hearing test module 304 modifies the hearing profile to include instructions for producing sounds based on a comparison of the hearing profile to the audiometric profile. For example, the hearing test module 304 may identify that there is a 10-decibel hearing loss at 400 Hertz based on comparing the hearing profile to the audiometric profile and the hearing profile is updated with instructions to produce sounds by increasing the auditory device by 10 decibels for any noises that occur at 400 Hertz.

The large language model 306 is a machine-learning model that is trained to recognize statistical relationships from text documents, statistical relationships from audio files, and associates text descriptions of sounds with audio profiles.

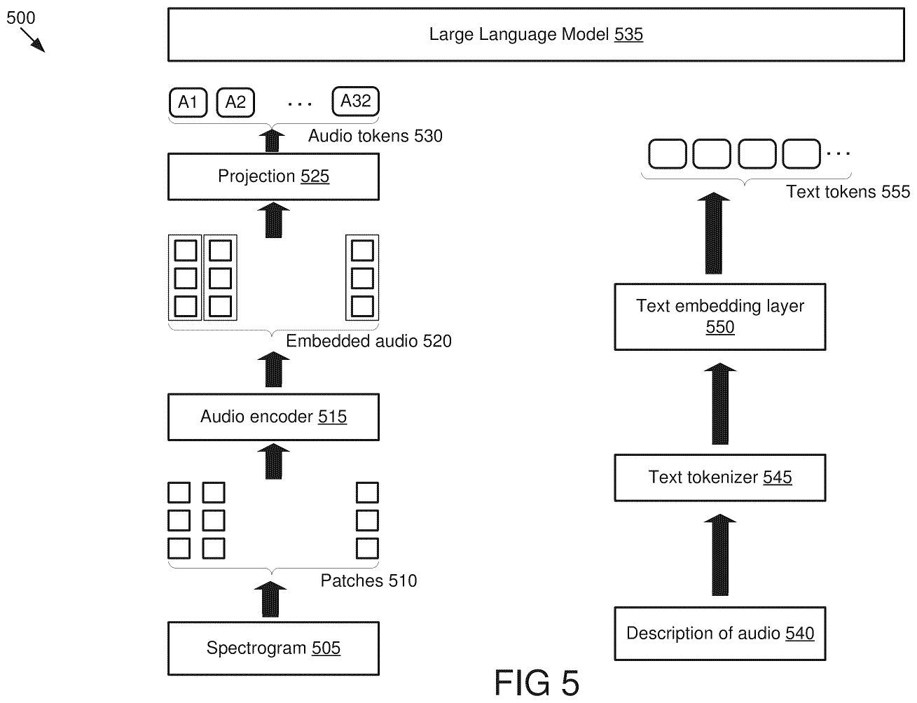

The large language model may take several architectural forms. FIG. 5 is an example process 500 of training a large language model to classify audio. In this example, the training includes an audio component and a text component.

The audio component begins training data in the form of spectrograms 505. The spectrogram 505 may be derived from a waveform. The spectrogram is a visual representation of frequencies of a signal as it varies as a function of time. The spectrogram 505 may be divided into patches 510, which are more digestible. Although FIG. 5 illustrates using spectrograms for training, in some embodiments, the waveform may be directly used for training and broken up into smaller audio samples for classification.

The patches 510 are provided as input to an audio encoder 515. The audio encoder 515 may be a perception model. The audio encoder 515 outputs a sequence of embedded audio 520. Embedded audio 520 includes feature embeddings that groups features of the audio based on similarity and identifies the position of each of the patches. The sequence of embedded audio 520 is projected to match the embedding dimensions of the large language model 535.

The embedded audio 520 is provided as audio to a projection layer 525, which outputs audio token 530.

The text component begins training data in the form of descriptions of audio 540 that correspond to the audio from the spectrograms 505. The description of audio 540 is provided to a text tokenizer 545, which separates the text into tokens that are combinations of letters, full words, or punctuation by removing punctuation and spaces. The tokenized text is provided to the text embedding layer 550, which includes feature embeddings that groups features of the text based on similarity and identifies the position of words within the overall sequence. The audio embeddings are concatenated with text embeddings as the input to the large language model 535. The text embedding layer 550 outputs text tokens 555, which are paired with the audio tokens 530 and provided as input to the large language model 535.

The large language model 535 may include learnable weights that are attached to a model layer. The learnable weights may use key and query in self-attention layers of the large language model 535. The loss function may be a cross-entropy loss function for maximizing P for a given text sequence and reference audio.

The large language model 535 is trained to associate the descriptions of audio with corresponding audio profiles. As a result, when the large language model 535 receives descriptions of audio, such as a name of an audio source (e.g., construction noise, bird sounds, person speaking, etc.) and audio sources that were split from audio captured in a physical environment, the large language model 535 identifies whether any of the descriptions of audio types from a user's profile that the user identified as positive audio or negative audio match any of the audio sources.

In some embodiments, the large language model 535 is also trained to identify directional instructions. For example, if a user instructions the auditory device to increase the volume of a person speaking to the left of the user, the large language model 535 may identify an audio source from audio captured by a microphone associated with the left auditory device (e.g., a left hearing aid, a left headphone, etc.).

The audio machine-learning model 308 is trained to split audio into audio sources. In some embodiments, the audio machine-learning model is a neural network. Neural networks can learn and model the relationships between input data and output data that are nonlinear and complex. The neural network may include an input layer, a hidden layer, and an output layer where each subsequent layer includes different levels of abstraction. For example, the layers may include a hierarchy where each successive layer recognizes more complex, detailed features. The input layer may receive input data, the hidden layer takes its input from the input layer or other hidden layers, and the output layer provides the final result of the data processing.

The audio machine-learning model 308 may be trained using supervised learning where the training data includes audio from a physical environment and the resulting separated audio. The training process may include a feedback process where users review resulting separated audio that is output by the audio machine-learning model 308 and rate the output on a scale to identify the quality of the separated audio.

Once the audio machine-learning model 308 is trained, the audio machine- learning model 308 receives audio in a physical environment from an auditory device. For example, the audio machine-learning model 308 receives audio of a user on a birding trip. The audio machine-learning model 308 splits the audio into audio sources. For example, the audio may be split into the sounds of birds, the sounds of people talking, and the sound of cars driving. The audio machine-learning model 308 provides the audio sources to the large language model 306 so that the audio sources can be matched with the types of audio that the user categorized as positive audio or negative audio. For any matched audio sources, the large language model 535 modifies the output of an auditory device. For example, if the matched audio source includes birds as a positive audio source, if the large language model 535 is stored on the auditory device, the large language model 535 may instruct the processor 335 and/or the digital signal processor 345 to increase the volume of the audio source for birds. In another example, if the matched audio source includes cars driving as a negative audio source and the large language model 535 is stored on the mobile device, the large language model 535 may instruct the auditory device to decrease the sound or cancel the sound of cars driving.

In some embodiments, there may be instances where a positive sound is attenuated or cancelled temporarily. For example, a user may identify human voices as positive audio. The large language model 306 may receive an instruction from the user to increase the volume of a particular person (e.g., “Increase Sarah's volume.”). The large language model 306 may temporarily increase the volume of Sarah while decreasing or cancelling the volume of other people even though human voices are identified as positive audio. In some embodiments, the large language model 306 may apply this modification until the audio machine-learning model 308 no longer identifies the audio associated with Sarah in the physical environment, at which point human voices identified in the physical environment revert back to being amplified.

### Example Method 600

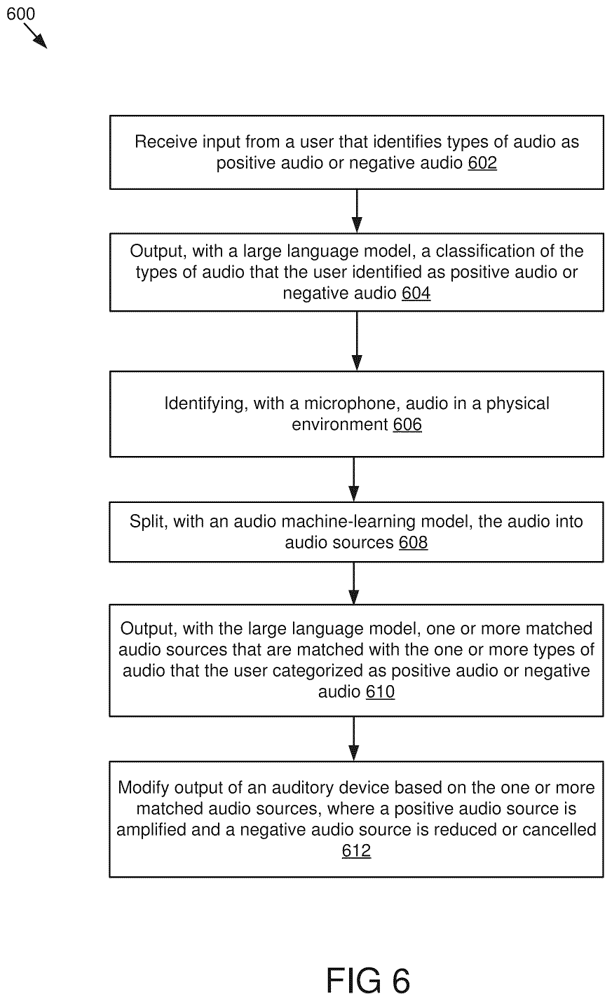

FIG. 6 illustrates a flowchart of an example method 600 to modify output of an auditory device based on one or more matched audio sources. The method 600 is implemented by one or more computing devices 300 as described with reference to FIG. 3A. The one or more computing devices 300 includes the auditory device 120, the mobile device 117, and/or the server 101 as illustrated in FIG. 1.

The method 600 may start with block 602. At block 602, input is received from a user that identifies types of audio as positive audio or negative audio. Block 602 may be followed by block 604.

At block 604, a large language model outputs a classification of the types of audio that the user identified as positive audio or negative audio. In some embodiments, the large language model is trained by: receiving training data that includes audio files and descriptions of the audio files; outputting, with an audio encoder, embedded audio; generating audio tokens; tokenizing the descriptions of the audio files; outputting, with a text embedding layer, text tokens; and providing pairs of audio tokens and corresponding text tokens to the large language model for training.

In some embodiments, responsive to receiving the input from the user, the method further includes generating a user interface that includes a list of the types of audio that the user identified as positive audio or negative audio, wherein the user interface includes options for specifying a degree of positive audio or a degree of negative audio. Block 604 may be followed by block 606.

At block 606, a microphone identifies audio in a physical environment. Block 606 may be followed by block 608.

At block 608, an audio machine-learning model splits the audio into audio sources. Block 608 may be followed by block 610.

At block 610, the large language model outputs one or more matched audio sources that are matched with the one or more types of audio that the user categorized as positive audio or negative audio. Block 610 may be followed by block 612.

At block 612, output of an auditory device is modified based on the one or more matched audio sources, where a positive audio source is amplified and a negative audio source is reduced or cancelled. In some embodiments, the method further includes detecting, with the microphone, an instruction from a user to increase a volume of a person; classifying, with the large language model, a particular type of audio based on the instruction from the user; and modifying output of the auditory device to increase the volume of the person.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end mobile devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method comprising:
receiving input from a user that identifies types of audio as positive audio or negative audio;
outputting, with a large language model, a classification of the types of audio that the user identified as positive audio or negative audio;
identifying, with a microphone, audio in a physical environment;
splitting, with an audio machine-learning model, the audio into audio sources;
outputting, with the large language model, one or more matched audio sources that are matched with the one or more types of audio that the user categorized as positive audio or negative audio; and
modifying output of an auditory device based on the one or more matched audio sources, wherein a positive audio source is amplified and a negative audio source is reduced or cancelled.

2. The method of claim 1, further comprising:
responsive to receiving the input from the user, generating a user interface that includes a list of the types of audio that the user identified as positive audio or negative audio, wherein the user interface includes options for specifying a degree of positive audio or a degree of negative audio; and
generating a user profile based on the input from the user.

3. The method of claim 2, further comprising:
detecting, with the microphone, an instruction from a user to increase or decrease a volume of a type of sound;
classifying, with the large language model, a particular type of audio based on the instruction from the user;
splitting, with the audio machine-learning model, the audio in the physical environment to isolate the particular type of audio; and
modifying the output of the auditory device based on the instruction from the user to increase or decrease the volume of particular type of audio.

4. The method of claim 3, further comprising:
updating the user profile to categorize the type of sound as positive audio or negative audio based on the instruction from the user.

5. The method of claim 1, further comprising:
detecting, with the microphone, an instruction from a user to increase a volume of a person;
classifying, with the large language model, a particular type of audio based on the instruction from the user; and
modifying output of the auditory device to increase the volume of the person.

6. The method of claim 5, wherein the instruction from the user further includes an identification of a location of the person as identified by the large language model and classifying the particular type of audio is further based on the location of the person.

7. The method of claim 1, wherein the large language model is trained by:
receiving training data that includes audio files and descriptions of the audio files;
outputting, with an audio encoder, embedded audio;
generating audio tokens;
tokenizing the descriptions of the audio files;
outputting, with a text embedding layer, text tokens; and
providing pairs of audio tokens and corresponding text tokens to the large language model for training.

8. The method of claim 1, wherein the positive audio source is amplified and the negative audio source is reduced or cancelled based on a degree of amplification or reduction input by the user.

9. A system comprising:
one or more processors; and
logic encoded in one or more non-transitory media for execution by the one or more processors and when executed are operable to:
receive input from a user that identifies types of audio as positive audio or negative audio;
output, with a large language model, a classification of the types of audio that the user identified as positive audio or negative audio;
identify, with a microphone, audio in a physical environment;
split, with an audio machine-learning model, the audio into audio sources;
output, with the large language model, one or more matched audio sources that are matched with the one or more types of audio that the user categorized as positive audio or negative audio; and
modify output of an auditory device based on the one or more matched audio sources, wherein a positive audio source is amplified and a negative audio source is reduced or cancelled.

10. The system of claim 9, wherein the logic is further operable to:
responsive to receiving the input from the user, generate a user interface that includes a list of the types of audio that the user identified as positive audio or negative audio, wherein the user interface includes options for specifying a degree of positive audio or a degree of negative audio; and
generate a user profile based on the input from the user.

11. The system of claim 10, wherein the logic is further operable to:
detect, with the microphone, an instruction from a user to increase or decrease a volume of a type of sound;
classify, with the large language model, a particular type of audio based on the instruction from the user;
split, with the audio machine-learning model, the audio in the physical environment to isolate the particular type of audio; and
modify the output of the auditory device based on the instruction from the user to increase or decrease the volume of particular type of audio.

12. The system of claim 11, wherein the logic is further operable to:
update the user profile to categorize the type of sound as positive audio or negative audio based on the instruction from the user.

13. The system of claim 9, wherein the logic is further operable to:
detect, with the microphone, an instruction from a user to increase a volume of a person;
classify, with the large language model, a particular type of audio based on the instruction from the user; and
modify output of the auditory device to increase the volume of the person.

14. The system of claim 13, wherein the instruction from the user further includes an identification of a location of the person as identified by the large language model and classifying the particular type of audio is further based on the location of the person.

15. Software encoded in one or more computer-readable media for execution by one or more processors of an auditory device and when executed is operable to:
receive input from a user that identifies types of audio as positive audio or negative audio;
output, with a large language model, a classification of the types of audio that the user identified as positive audio or negative audio;
identify, with a microphone, audio in a physical environment;
split, with an audio machine-learning model, the audio into audio sources;
output, with the large language model, one or more matched audio sources that are matched with the one or more types of audio that the user categorized as positive audio or negative audio; and
modify output of an auditory device based on the one or more matched audio sources, wherein a positive audio source is amplified and a negative audio source is reduced or cancelled.

16. The software of claim 15, wherein the software is further operable to:
responsive to receiving the input from the user, generate a user interface that includes a list of the types of audio that the user identified as positive audio or negative audio, wherein the user interface includes options for specifying a degree of positive audio or a degree of negative audio; and
generate a user profile based on the input from the user.

17. The software of claim 16, wherein the software is further operable to:
detect, with the microphone, an instruction from a user to increase or decrease a volume of a type of sound;
classify, with the large language model, a particular type of audio based on the instruction from the user;
split, with the audio machine-learning model, the audio in the physical environment to isolate the particular type of audio; and
modify the output of the auditory device based on the instruction from the user to increase or decrease the volume of particular type of audio.

18. The software of claim 17, wherein the software is further operable to:
update the user profile to categorize the type of sound as positive audio or negative audio based on the instruction from the user.

19. The software of claim 15, wherein the software is further operable to:
detect, with the microphone, an instruction from a user to increase a volume of a person;
classify, with the large language model, a particular type of audio based on the instruction from the user; and
modify output of the auditory device to increase the volume of the person.

20. The software of claim 19, wherein the instruction from the user further includes an identification of a location of the person as identified by the large language model and classifying the particular type of audio is further based on the location of the person.
